(19) United States
(12) Patent Application Publication
(10) Pub. No.: US 2012/0175382 A1
(43) Pub. Date: Jul. 12, 2012

(54) Liquid Container

(76) Inventors: Talisha N. McAuley-Davis, Chesterfield, VA (US); Wilbert C. Davis, JR., Chesterfield, VA (US)

(21) Appl. No.: 13/004,093

(22) Filed: Jan. 11, 2011

(51) Int. Cl. B67D 7/58

(52) U.S. Cl. 222/1; 222/321.7

(57) ABSTRACT

A liquid container and method for operating the same, that includes a disbursement cap that disburses liquid stored within liquid container, an upper body portion and a lower body portion combined, together to form an integral bottle portion of the liquid container for storing the liquid therein, and a connection mechanism that connects connect and disconnect the upper body portion to and from the lower body portion via a user.

### BACKGROUND

The present invention relates to a liquid container, and more specifically, to an improved liquid, container for disbursing liquids such as lotions and creams.

Liquid containers are used for disbursement of various liquid products. Lotions and Cream products may be disbursed via a liquid container that includes a body portion, a disbursement cap portion and retrieving portion for retrieving the lotion within the liquid container. There are several problems associated with the conventional liquid containers. Typically, the conventional lotion containers do not enable a user to retrieve all of the lotion or cream composition therein. That is, there may be a remaining portion of the lotion or cream product trapped within a bottom portion of the liquid container. Thus, the liquid container is typically thrown away with the remaining portion of the lotion still trapped therein. Thus, some disadvantages include waste of unused lotion or cream products and associated cost.

Therefore, it is desirable to provide a liquid container that enables users to retrieve the entire lotion or cream product contained within the liquid container.

### SUMMARY

According to one embodiment of the present invention, a liquid container is provided. The liquid container includes a disbursement cap configured to disburse liquid stored within liquid container, an upper body portion and a lower body portion configured to be combined together to form an integral bottle portion of the liquid container for storing the liquid therein, and a connection mechanism configured to connect and disconnect the upper body portion to and from the lower body portion via a user.

According to another embodiment of the present invention, a method for operating a liquid container is provided. The method includes providing a liquid container having an upper body portion and a lower body portion combined together to form an integral bottle portion for storing liquid therein, and a connection mechanism for connecting and disconnecting the upper body portion to and from the lower body portion. The method further includes connecting, via the connection mechanism, the upper body portion and the lower body portion, and disconnecting, via the connection mechanism, the upper body portion from the lower body portion by a user, to retrieve the liquid stored within the lower body portion.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1A is a diagram illustrating a liquid container that can be implemented within embodiments of the present invention.

FIG. 1B is a diagram illustrating a liquid container that can be implemented within embodiments of the present invention.

FIG. 2A is a diagram illustrating a liquid container that can be implemented within alternative embodiments of the present invention.

FIG. 2B is a diagram illustrating an interior surface of an upper body portion of the liquid container shown in FIG. 2A that can be implemented within embodiments of the present invention.

FIG. 3 is a diagram illustrating a liquid container that can be implemented within alternative embodiments of the present invention.

FIG. 4 is a diagram illustrating a liquid container that can be implemented within alternative embodiments of the present invention.

### DETAILED DESCRIPTION

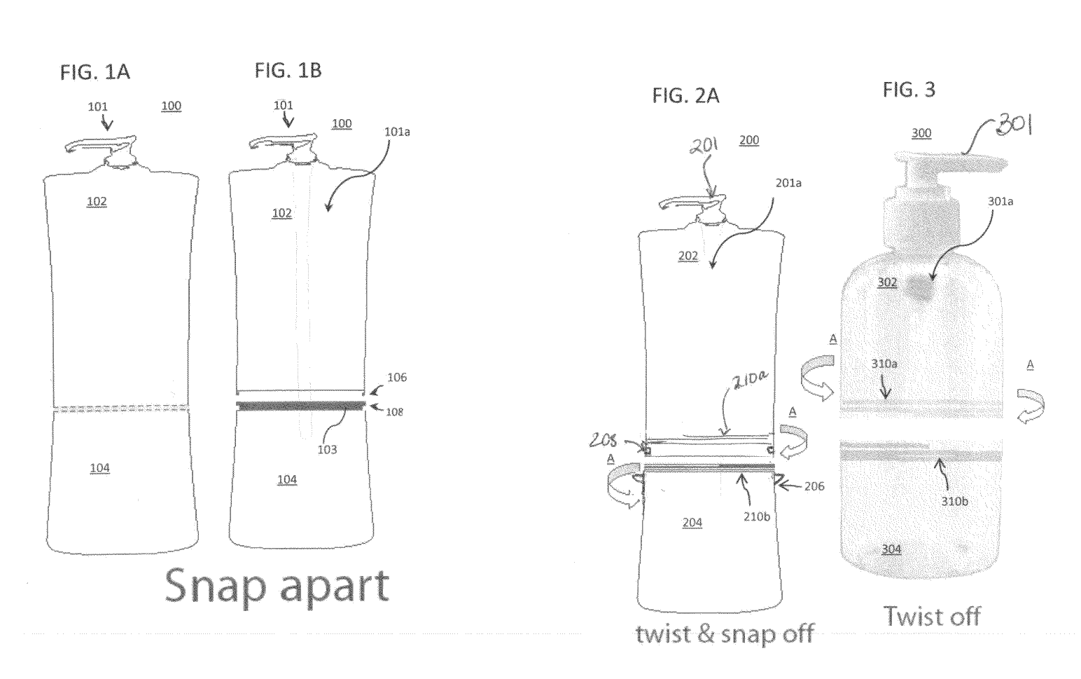

With reference now to FIG. 1A, a diagram illustrating a liquid container 100 according to embodiments of the present invention is provided. The liquid container 100 includes a disbursement cap 101 for disbursing the liquid stored with the liquid container 100. According to an embodiment of the present invention, a liquid retrieving portion 101a (as depicted in FIG. 1B, for example) may be operably connected with the disbursement cap 101 and used for retrieving the liquid contained within the liquid container 100. The present invention is not limited to the liquid retrieving portion 101a as shown in FIG. 1B, for example, any suitable liquid retrieving portion may be utilized. Further, according to another embodiment of the present invention, the liquid retrieving portion 101a may be omitted. According to, an embodiment of the present invention, the liquid container 100 further includes at least two body portions, (e.g., an upper body portion 102 and a lower body portion 104). The body portions 102 and 104 are configured to be combined together to form an integral bottle portion of the liquid container 100 for storing the liquid therein. That is, the body portions 102 and 104 form a single body portion of the liquid container 100. The body portions 102 and 104 may be formed of varying shapes. Further, these portions 102 and 104 may be formed of a flexible plastic material, for example, or any material suitable for the purpose set forth herein.

According to an embodiment of the present invention, the liquid may be that of a lotion or a cream composition. For example, it may be shampoo, conditioner, body lotion, tanning lotion, facial cleanser or cream, perfume cream, or food product such as ketchup, mustard, or salad dressing, for example. The present invention is not limited to any particular use of the liquid container 100 and may vary accordingly. Thus, the liquid container 100 may be used for any suitable purpose as set forth herein.

A connection mechanism is also provided to assist the user in retrieving the liquid stored within the liquid container 100 in the event that a remaining portion of the liquid is trapped within a bottom portion of the lower body portion 104. The connection mechanism is used to connect and disconnect the upper body portion 102 to and from the lower body portion 104. One example of the connection mechanism is illustrated in FIG. 1B. As shown in FIG. 1B, the connection mechanism includes a plurality of hook portions 106 formed at an end of one of the upper body portion 102 or the lower body portion 104, and a plurality of hook receiving portions 108 formed at an end of the other of the upper body portion 102 or the lower body portion 104. In this example, the hook portions 106 are formed at an end of the upper body portion 102 and the hook receiving portions 108 are formed at an end of the lower body portion 104 however the present invention is not limited hereto. The formation of the hook portions 106 and the hook receiving portions 108 may be at either end of the upper body portion 102 and the lower body portion 104 such that they operate in a manner as set forth herein. According to an embodiment of the present invention, a sealant 103 may also be provided along the body portion 102 or 104 which includes the hook receiving portions 108. The sealant 103 is used to seal the connection between the upper body portion 102 and the lower body portion 104 and to thereby prevent leakage of the liquid stored therein. The sealant may be formed of a rubber material or other suitable material, for example. As shown in FIG. 1B, for example, a sealant 103 is formed at an upper portion of the lower body portion 104 which includes the hook receiving portions 108. The operation of the connection mechanism according to this embodiment will now be described.

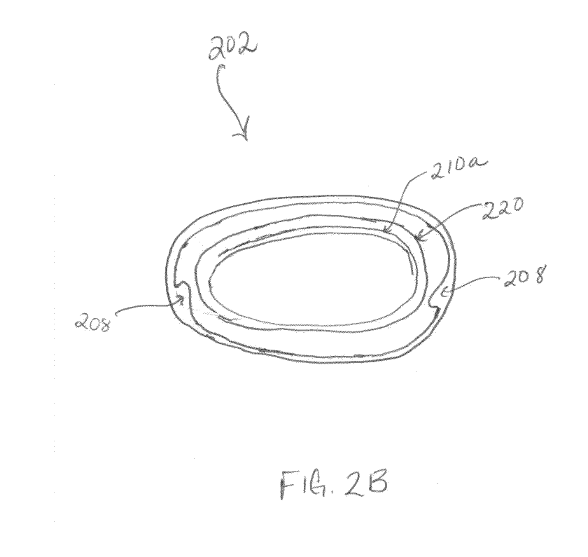

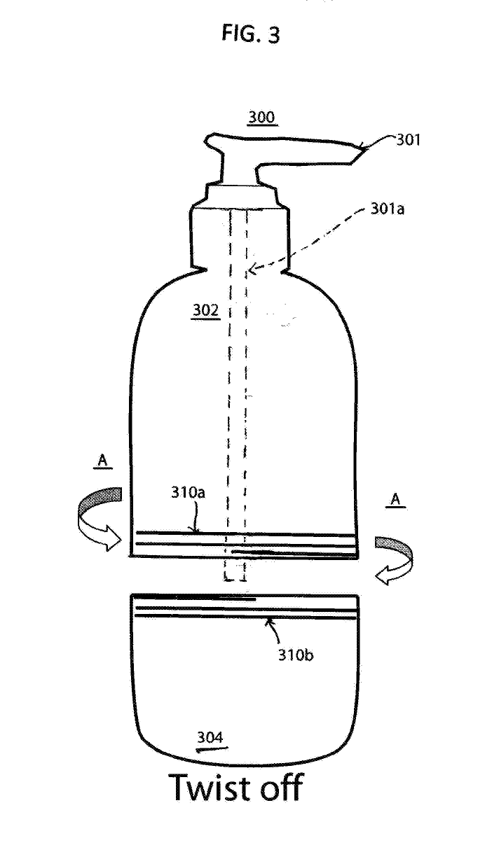

According to an embodiment, the hook portions 106 are inserted and secured within the hook receiving portions 108 to connect the upper body portion 102 with the lower body portion 104. As shown in FIG. 1B, when the upper body portion 102 is connected with the lower body portion 104 the sealant 103 will be disposed at the connection point between the two portions 102 and 104 and prevents leakage of liquid therefrom. In order to disconnect the body portions 102 and 104 from each other, the hook, receiving portions 108 are compressed. The present invention is not limited to any particular type of connection mechanism and any suitable connection mechanism may be implemented herein. Other examples of connection mechanisms and associated operation will now be described below with reference to FIGS. 2 and 3.

FIG. 2A is a diagram illustrating a liquid container that can be implemented within alternative embodiments of the present invention; and FIG. 2B is a diagram illustrating an inner surface of an upper body portion of the liquid container shown in FIG. 2B. The liquid container 200 includes a disbursement cap 201 and a liquid retrieving portion 201a which operate in a same manner as that of FIGS. 1A and 1B, therefore a detailed description thereof is omitted. The liquid container 200 further includes an upper body portion 202 and a lower body portion 204 and a connection mechanism for connecting and disconnecting the portions 202 and 204 to and from each other. The connection mechanism according to this embodiment is of a twist and snap function (e.g., a snap and ¼ twist function). That is, the connection mechanism includes a plurality of hook portions 206 formed at an end of one of the upper body portion 202 or the lower body portion 204, a plurality of hook receiving portions 208 formed at an end of the other of the upper body portion 202 or the lower body portion 204. The liquid container 200 further includes a first twisting portion 210a formed on the end of one of the upper body portion 202 or the lower body portion 204 and a second twisting portion 210b formed on the end of the other of the upper body portion 202 or the lower body portion 204. As shown in FIGS. 2A and 2B, the liquid container 200 includes the hook portions 206 formed on the lower body portion 204 and the hook receiving portions 208 formed on the upper body portion 202. Further, the first twisting portion 210a on an inner surface 220 (as depicted in FIG. 2B) of the upper body portion 202 above the hook receiving portions 208 which are formed near the end of the upper body portion 202 that is connectable with the lower body portion 204. Further, the second twisting portion 210b is formed at an end of the lower body portion 204 adjacent to the hook portions 206. As shown in FIG. 2A, the hook portions 206 are formed beneath the second twisting portion 210b. The present invention is not limited to the formation of these portions 206, 208 and 210a and 210b and thus the formation of the same may be on one or the other of the upper body portion 202 or the lower body portion 204. Further, a sealant 103 (as depicted in FIG. 1B) may also be provided. An operation of the liquid container 200 will now be described.

According to an embodiment of the present invention, the first twisting portion 210a and, the second twisting portion 210b are twisted together by twisting one of the first or second twisting portions 210a and 210b in a first direction indicated by arrows ‘A’ to connect to each other, and the hook portions 206 are then subsequently inserted and secured within the hook receiving portions 208 to further connect the upper body portion 202 with the lower body portion 204. On the other hand, in order to disconnect the upper body portion 202 from the lower body portion 204, the hook receiving portions 206 are compressed to partially disconnect the upper body portion 202 from the lower body portion 204 and the first twisting portion 210a and second twisting portion 210b are then subsequently twisted apart by twisting one of the first or second twisting portions 210a or 210b in a second direction opposite the first direction.

FIG. 3 is a diagram illustrating a liquid container that can be implemented within alternative embodiments of the present invention. As shown in FIG. 3, the liquid container 300 includes a disbursement cap 301 and a liquid retrieving portion 301a which operate in a same manner as that of FIGS. 1A, 1B and 2, therefore a detailed description thereof is omitted. The liquid container 300 further upper and lower body portions 302 and 304 and a connecting mechanism including first twisting portion 310a formed at an end of one of the upper body portion 302 or the lower body portion 304; and a second twisting portion 310b formed at an end of the other of the upper body portion 302 or the lower body portion 304. According to this embodiment of the present invention, the first twisting portion 310a and the second twisting portion 310b are twisted together by twisting one of the first or second twisting portions 310a and 310b in a first direction indicated by arrows A, to connect to each other. By doing so, the two portions 302 and 304 form an integral bottle portion for storing the liquid therein. A user may disconnect the two portions 302 and 304 from each other by twisting them apart. That is, by twisting one of the first or second twisting portions 310a and 310b in a second direction opposite the first direction.

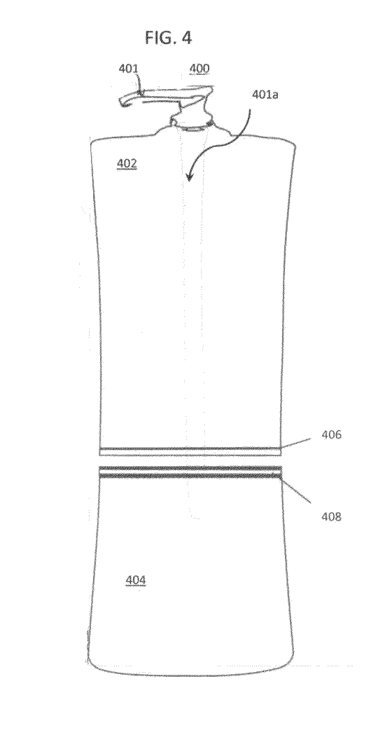

FIG. 4 is a diagram illustrating a liquid container that can be implemented within alternative embodiments of the present invention. As shown in FIG. 4, the liquid container 400 includes a disbursement cap 401 and a liquid retrieving portion 401a which operate in a same manner as that of FIGS. 1A and 1B, therefore a detailed description thereof is omitted. The liquid container 400 further includes an upper body portion 402 and a lower body portion 404 and a connection mechanism for connecting and disconnecting the portions 402 and 404 to and from each other. According to an embodiment of the present invention, the connection mechanism includes protruding portion 406 (e.g., a male connector) and a groove portion 408 (i.e., a female connector) for receiving the protruding portion 406 therein. According to an embodiment of the present invention, the protruding portion 406 may be formed on an interior surface of the upper or lower body portion 402 or 404 and the groove portion 408 may be formed on the other of the upper or lower body portion 402 or 404. The upper body portion 402 and the lower body portion 404 are connected together by pressing the portions 402 and 404 together such that the protruding portion 406 is inserted into the groove portion 408 and snapped into place to secure the connection between portions 402 and 404.

The present invention provides a liquid container that provides a plurality of body portions integrally combined to form a single bottle and enables a user to disconnect the body portions to retrieve trapped liquid (e.g., lotion) stored within the body portions of the liquid container. Therefore, the present invention provides the advantage of saving costs to the user and preventing waste of unused liquid within the liquid container.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A liquid container comprising:
a disbursement cap configured to disburse liquid stored within liquid container;
an upper body portion and a lower body portion configured to be combined together to form an integral bottle portion of the liquid container for storing the liquid therein; and
a connection mechanism configured to connect and disconnect the upper body portion to and from the lower body portion via a user.

2. The liquid container of claim 1, further comprising: a liquid retrieving portion operably connected with the disbursement cap and configured to retrieve the liquid stored within the liquid container.

3. The liquid container of claim 1, wherein the upper body portion and the lower body portion are formed of varying shapes to be combined together.

4. The liquid container of claim 1, wherein the connection mechanism comprises:
a plurality of hook portions formed at an end of one of the upper body portion or the lower body portion; and
a plurality of hook receiving portions formed at an end of the other of the upper body portion or the lower body portion, wherein:
the hook portions are inserted and secured within the hook receiving portions to connect the upper body portion with the lower body portion, and the hook receiving portions are compressed to disconnect the upper body portion from the lower body portion.

5. The liquid container of claim 1, wherein the connection mechanism comprises:
a first twisting portion formed at an end of one of the upper body portion or the lower body portion; and
a second twisting portion formed at an end of the other of the upper body portion or the lower body portion,
wherein the first twisting portion and the second twisting portion are twisted together by twisting one of the first or second twisting portions in a first direction to connect to each other, and the first twisting portion and second twisting portion are twisted apart by twisting one of the first or second twisting portions together in a second direction opposite the first direction.

6. The liquid container of claim 1, wherein the connection mechanism comprises:
a plurality of hook portions formed at an end of one of the upper body portion or the lower body portion;
a plurality of hook receiving portions formed at an end of the other of the upper body portion or the lower body portion;
a first twisting portion formed on the end of one of the upper body portion or the lower body portion; and
a second twisting portion formed on the end of the other of the upper body portion or the lower body portion
wherein the first twisting portion and the second twisting portion are twisted together by twisting one of the first or second twisting portions in a first direction to connect to each other, and the hook portions are inserted and secured within the hook receiving portions to further connect the upper body portion with the lower body portion, and
wherein the hook receiving portions are compressed to partially disconnect the upper body portion from the lower body portion and the first twisting portion and second twisting portion are further twisted apart by twisting one of the first or second twisting portions in a second direction opposite the first direction.

7. The liquid container of claim 1, wherein the liquid comprises at least one of a lotion or a cream composition.

8. The liquid container of claim 1, wherein the upper body portion and the lower body portion are formed of a flexible plastic material.

9. The liquid container of claim 1, further comprising a sealant formed along a surface of at least one of the upper body portion or the lower body portion where the upper body portion and the lower body portion are to be connected, wherein the sealant blocks leakage of the liquid stored within the liquid container.

10. The liquid container of claim 1, wherein the connection mechanism comprises:
a protruding portion formed on one of the upper body portion or the lower body portion; and
a groove portion formed on the other of the upper body portion or the lower body portion, wherein the protruding portion is inserted into the groove portion to connect the upper body portion with the lower body portion.

11. A method for operating a liquid container, the method comprising:
providing a liquid container having an upper body portion and a lower body portion combined together to form an integral bottle portion for storing: liquid therein, and a connection mechanism for connecting and disconnecting the upper body portion to and from the lower body portion;
connecting, via the connection mechanism, the upper body portion and the lower body portion;
disconnecting, via the connection mechanism, the upper body portion from the lower body portion by a user, to retrieve the liquid stored within the lower body portion.

12. The method of claim 11, further comprising:
disbursing, via a disbursement cap, the liquid stored within liquid container, and
retrieving the liquid stored therein, via a liquid retrieving portion operably connected with the disbursement cap.

13. The method of claim 11, wherein connecting the upper body portion with the lower body portion comprises:
providing a plurality of hook portions formed on one of the upper body portion or the lower body portion, and a plurality of hook receiving portions formed on the other of the at least one of the upper body portion or the lower body portion; and
inserting and securing the hook portions within the hook receiving portions.

14. The method of claim 11, wherein disconnecting the upper body portion from the lower body portion comprises:
compressing the hook receiving portions to disconnect the upper body portion from the lower body portion.

15. The method of claim 11, wherein connecting the upper body portion to the lower body portion comprises:
providing a first twisting portion formed on an end of one of the upper body portion or the lower body portion, and a second twisting portion formed on an end of the other of the upper body portion or the lower body portion; and
twisting one of the first or second twisting portions in a first direction to connect to each other.

16. The method of claim 11, wherein disconnecting the upper body portion from the second body portion comprises:
disconnecting the first and second twisting portions by twisting one of the first or second twisting portions in a second direction opposite the first direction.

17. The method of claim 11, wherein connecting the upper body portion to and from lower body portion comprises:
providing a plurality of hook portions formed on one of the upper body portion or the lower body portion, a plurality of hook receiving portions formed on the other of the at least one of the upper body portion or the lower body portion, a first twisting portion formed on an end of one of the upper body portion or the lower body portion, and a second twisting portion formed on an end of the other of the upper body portion or the lower body portion;
twisting one of the first or second twisting portions in a first direction to connect to each other and subsequently inserting and securing the hook portions within the hook receiving portions.

18. The method of claim 11, wherein disconnecting the upper body portion from the lower body portion comprises:
compressing the hook receiving portions to disconnect the upper body portion from the lower body portion, and subsequently disconnecting the first and second twisting portions by twisting one of the first or second twisting portions in a second direction opposite the first direction.

19. The method of claim 11, wherein the liquid comprises at least one of a lotion or a cream composition.

20. The method of claim 11, wherein the upper body portion and the lower body portion are formed of a flexible plastic material.
